(19) United States
(12) Patent Application Publication
(10) Pub. No.: US 2014/0278107 A1
(43) Pub. Date: Sep. 18, 2014

(54) METHODS AND SYSTEMS FOR REAL-TIME SOLAR FORECASTING INCORPORATING A GROUND NETWORK

(71) Applicants: Shawn Kerrigan, Redwood City, CA (US); Matthew Williams, San Francisco, CA (US); Sergey Koltakov, Palo Alto, CA (US); Alexander Thornton, San Francisco, CA (US)

(72) Inventors: Shawn Kerrigan, Redwood City, CA (US); Matthew Williams, San Francisco, CA (US); Sergey Koltakov, Palo Alto, CA (US); Alexander Thornton, San Francisco, CA (US)

(73) Assignee: Locus Energy, LLC

(21) Appl. No.: 13/796,367

(22) Filed: Mar. 12, 2013

(51) Int. Cl. G01W 1/10

(52) U.S. Cl. CPC G01W 1/10
USPC 702/3

(57) ABSTRACT

This application relates generally to systems and methods for validating solar irradiance nowcasts, solar power nowcasts and forecasts in real-time using a network of solar power systems and solar irradiance sensors. This application also relates to systems and methods for augmenting solar irradiance forecasts and solar power forecasts in real-time using a network of solar power systems and solar irradiance sensors.

This application relates generally to systems and methods for validating solar irradiance nowcasts, solar power nowcasts and forecasts in real-time using a network of solar power systems and solar irradiance sensors. This application also relates to systems and methods for augmenting solar irradiance forecasts and solar power forecasts in real-time using a network of solar power systems and solar irradiance sensors.

In recent years, the number of operational solar energy installations has grown rapidly at the residential, commercial, and utility scale. While in aggregate solar power generation is still only a small percentage of the energy produced in the United States, the volatility of photovoltaic (PV) solar power production causes it to have a disproportionate impact on the electric grid. For grid operators to efficiently manage and plan for the integration of high penetration solar into the electric grid, the current and near-future irradiance available and power generated by distributed solar within a region needs to be understood. For these forecasts to be effectively used, the forecast accuracy must be quantified against ground measurements in real-time, as well as on a historical basis.

Existing solar irradiance and power forecast models have proven effective, but they lack the ability to augment and update forecasts in real-time using ground observations. Forecasts are imperfect and frequently have errors caused by hidden relationships between inputs, missing inputs, and forecasted output. The present invention leverages machine learning techniques, data from a monitored network of distributed solar installations and weather sensors to adaptively augment and update solar irradiance and power forecasts.

These and other features, aspects and advantages of the present invention will become better understood with reference to the following description and claims.

### SUMMARY OF THE INVENTION

The present invention relates to methods and systems for validating and augmenting solar irradiance and solar power production forecasts using a monitored network of solar power systems and solar irradiance sensors.

According to one embodiment of the present invention, a computer processor implemented method of validating solar irradiance forecasts is provided, the method comprising the steps of; providing a set of renewable energy systems having at least two renewable energy systems each having a measured solar irradiance from a solar irradiance weather sensor at a location n and time t and an estimated solar irradiance from a solar irradiance forecast feed at a location n and time t in a computer processor; determining by the computer processor a set of matched pairs of location n and time t from the measured solar irradiance from a from weather sensor at a location n and time t and the estimated solar irradiance from a solar irradiance forecast feed at a location n and time t; calculating a validation metric of the set of matched pairs by the computer processor for at least one of: all locations at time t; location n at all times; all locations at all times; a subset of locations at time t; location n at a subset of times; and a subset of locations at a subset of times.

According to another embodiment of the present invention, a computer processor implemented method of validating solar power production forecasts is provided, the method comprising the steps of; providing a set of renewable energy systems having at least two renewable energy systems each having a measured power production from a from power meter at a location n and time t and an estimated solar power production from a solar power production forecast feed at a location n and time t in a computer processor; determining by the computer processor a set of matched pairs of location n and time t from the measured power production from a from power meter at a location n and time t and an estimated solar power production from a solar power production forecast feed at a location n and time t in a computer processor; calculating a validation metric of the set of matched pairs by the computer processor for at least one of: all locations at time t; location n at all times; all locations at all times; a subset of locations at time t; location n at a subset of times; and a subset of locations at a subset of times.

According to another embodiment of the present invention, a computer processor implemented method of augmenting solar irradiance forecasts is provided, the method comprising the steps of; providing in a computer processor a set of solar irradiance sensors having at least two solar irradiance sensors each having a measurement of solar irradiance at location n and at time t and forecasted solar irradiance data at location n and at time t; determining in the computer processor at least one set of solar irradiance data variables at a location n and time t; matching by the computer processor all data variables at location n and time t, including all locations within distance d of location n and all time periods with s time periods of time t at those locations to provide a matched set of solar irradiance data variables at a location n and time t; training a machine learning algorithm to minimize to provide a trained machine learning algorithm according to: Σᵢ₌₁^{j}Measured Solar Irradianceₙᵢ−\hat{f}(•ₙᵢ) where j is the number of time points for which data is available to train the algorithm, •ₙᵢ is the matched set of solar irradiance data variables at a location n and time t and \hat{f}(•ₙᵢ) is a function for predicting solar irradiance at location n at time i using data •ₙᵢ; augmenting the forecasted solar irradiance data using the trained machine learning algorithm: Augmented Forecasted Solar Irradianceₙₜ=\hat{f}(•ₙₜ) where •ₙₜ is the matched set of solar irradiance data variables at a location n and time t and \hat{f}(•ₙₜ) is a function for predicting solar irradiance at location n at time t using data •ₙₜ.

According to another embodiment of the present invention, a computer processor implemented method of augmenting solar power production forecasts, said method comprising the steps of; providing in a computer processor a set of solar power meters having at least two solar power meters each having a measurement of power production at location n and at time t and forecasted power production at location n and at time t; determining in the computer processor at least one set of solar power production data variables at a location n and time t; matching by the computer processor all solar power production data variables at location n and time t, including all locations within distance d of location n and all time periods with s time periods of time t at those locations to provide a matched set of solar power production data variables at a location n and time t; training a machine learning algorithm to minimize to provide a trained machine learning algorithm according to: Σᵢ₌₁^{j}Measured Solar Irradianceₙᵢ−\hat{f}(•ₙᵢ) where j is the number of time points for which data is available to train the algorithm, •ₙₜ is the matched set of solar power production data variables at a location n and time t and \hat{f}(•ₙₜ) is a function for predicting solar power production at location n at time i using data •ₙₜ; augmenting the forecasted solar power production data using the trained machine learning algorithm: Augmented Forecasted Solar Irradianceₙₜ=\hat{f}(•ₙₜ) where •ₙₜ is the matched set of solar power production data variables at a location n and time t and \hat{f}(•ₙₜ) is a function for predicting solar power production at location n at time t using data •ₙₜ.

These and other features, aspects and advantages of the present invention will become better understood with reference to the following description and claims.

### BRIEF DESCRIPTION OF THE DRAWINGS

FIG. 1 depicts the present invention;

FIG. 2 depicts the present invention;

FIG. 3 depicts the present invention;

FIG. 4 depicts the present invention;

FIG. 5 depicts the present invention;

FIG. 6 depicts the present invention;

FIG. 7 depicts the present invention;

FIG. 8 depicts the present invention;

FIG. 9 depicts the present invention; and

FIG. 10 depicts the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

FIGS. 1-5 provide examples of a monitored renewable energy system (more specifically a photovoltaic array solar panel also referred to herein as a solar photovoltaic system or solar powered system) from which information may be obtained. According to the example shown, there is a server 10 and at least one monitored renewable energy system (e.g. 102, 104, 106, 108, 110, 112) which is provided to a user or consumer. There may be at least one data server (10), at least one generation monitoring device (16) in communication with the monitored renewable energy system (at premise monitored renewable energy system (30)) and at least one communication node (22) in communication with at least one of the monitored renewable energy system (30), the generation monitoring device (16) and the data server (10). It should be understood the data server may be a single computer, a distributed network of computers, a dedicated server, any computer processor implemented device or a network of computer processor implemented devices, as would be appreciated by those of skill in the art. It should also be understood that each step of the present invention may be performed by a computer/computer processor. The monitored renewable energy system may have background constants that are entered into the system during data setup; populating this part of the data structure is one of the initial steps to the process. During this time, all required (or potentially required) background information may be loaded into the system. This data will later be used for system calculations and diagnostics. Background constants may include: (1) Full Calendar with sunrise and sunset according to latitude throughout the year; (2) Insolation or ‘incident solar radiation’: This is the actual amount of sunlight falling on a specific geographical location. There are expected amounts of radiation which will fall on an area each day, as well as an annual figure. Specific Insolation is calculated as kWh/m2/day. The importance of this variable is that it can combine several other Background Constants; and (3) Location Functionality. It is envisioned that some of this information may be input and some may be determined automatically. The proximity of each system to each other system may be determined, and forms a part of the methods used to determine the geographic average of the renewable energy systems. While there are different specific methods of implementing Location Functionality, generally this relies on a large database of locations which are tied to zones. Because the relational distances between the zones are stored within the software, the distances between any two locations can then be easily and accurately calculated.

The term production data refers to any data that is received from the renewable energy system and/or solar irradiance sensor. The energy generated by each monitored renewable energy system and/or solar irradiance sensor is recorded as production data and the data server may then determine comparative information based upon at least one of the background constant, the diagnostic variable, the system coefficient and the energy generated to determine a comparative value of the monitored renewable energy system. The term comparative value is intended to include any value that compares one system to another system or a group of systems. For example, this may be as simple as an “underperforming” designation when the system's performance is less than another system or group of systems performance in terms of power generated.

A sample system may have at least one inverter (14) in communication with the monitored renewable energy system (e.g. 50, 30). The inverter (14) is an electronic circuit that converts direct current (DC) to alternating current (AC). There may also be at least one return monitor (18) determining the energy returned to a grid by the at-least one monitored renewable energy system. At least one background constant may be determined and saved in the data server(s). The monitored renewable energy system (e.g. 30, 50) may be at least partially powered by at least one alternate energy source. There may be at least one generation monitoring device (e.g. 58), which calculates the energy generated at each consumer's premises by the monitored renewable energy system (e.g. 30, 50); at least one communication node (64) in communication with each at least one generation monitoring device (e.g. 58); at least one data server (10) in communication with communication node (e.g. 64), wherein the data server(s) (10) accept information from the communication node (e.g. 64) to determine the power generated at a first user's premises (100) and compare the power generated at a first user's premises (100) to Comparative Information obtained from at least two monitored renewable energy systems (e.g. 102, 104, 106, 108, 110, 112, 114) to determine if the first user's monitored renewable energy system (100) is within a predetermined deviation from the comparative information. This may provide a comparative value. The communication node may be further comprising a data storage means for storing usage information. For example, the communication node (64) may be a computer with a hard drive that acts as a data storage means for storing usage information. The generation monitoring device may be selected from the group consisting of pulse meter, temperature meter, electromechanical meter, solid state meter, flow meter, electric meter, energy meter and watt meter. There may also be at least one return monitoring device in communication with the inverter which calculates the energy returned to a grid by the system.

The monitored renewable energy system may be, for example, a solar system, solar panel system, photovoltaic, thermal, wind powered, geothermal, hydropower. A secondary energy source (e.g. 52) may be in communication with and at least partially powering the monitored renewable energy system. It should be understood, though, this is only for ancillary power in the event that the renewable energy source (50) is not capable of entirely powering the at premise monitored renewable energy system.

The generation monitoring device may be any type of meter, by way of example, this may include a pulse meter, temperature meter, electromechanical meter, solid state meter, flow meter, electric meter, energy meter and watt meter. An installation will have a communication node or hub set up at the location with the system. One of the communication nodes may act as a hub. These devices connect to the internet and send the data collected by the nodes to the Server. They have the following properties: The hub has a web server and connects to a standard internet connection (Ethernet). It does not require a computer or other device to make this connection. Each hub has its own unique IP or DNS address. The hub is configured by a web browser. The web browser allows the hub to have specific nodes assigned to it. This set up feature will allow another hub in the area to be set up with its own nodes so that all can operate wirelessly without disruption. Also, the hub is able to configure specific aspects of the hub, such as the connection with the server, data recording and time settings and the ability to configure the attached nodes, including their recording properties.

Each installation may have two or more Data Nodes. These are typically connected wirelessly to the Hub, and connected directly to the inputs/outputs from the Solar Hot Water system. They communicate constantly with the Hub, transferring data which the Hub then sends up to the server. They may have the following properties: The first Required Node connects to a flow meter attached to the Water Tank that is connected to the Solar Hot Water system. This Node will operate as a pulse meter, ‘clicking’ whenever a unit (either a gallon or a liter) of hot water passes from the tank. The second Required Node connects to either the electric panel at the switch for the Hot Water tank's electric power OR to a flow/other meter for gas/oil to the secondary heater for the Hot Water tank. The Node may have a data storage means for storing flow/usage information. Together, the data gathered from these Required Node connections allow the software on the serve to convert the utilized hot water into an accurate reading of utilized solar energy by subtracting the energy required to by the secondary heating mechanism. The term utilized generation refers to the energy generated by the at-premise power system, less any energy that has not been consumed by the at premise power system (e.g. the energy used to heat water that remains in the tank and is not subsequently used). Note that the term “at-premise power system” is one type of monitored renewable energy system, as claimed. There may also be other Nodes, which may be used to measure other aspects of the system and gain even more accurate readings. For example: the temperature of the hot water on an ongoing basis. The system may be monitored from a remote location (such as a computer in a different location).

The components node (100), hub (102) and server (10) make up the required core components needed to accurately measures the actual usable output from a Solar Hot Water (SHW) system. Essentially, the hub (102) connects to multiple nodes (100) which simultaneously measure the secondary power going into the system along with the hot water going out. Controlling for any background power requirements (e.g. for pumping), it can measure the usable BTUs created by solar by analyzing the measurements at the server (104) level.

The renewable energy system may be a solar system, solar panel system, photovoltaic, thermal, wind powered, geothermal, hydropower or any other renewable energy system. Also, the terms at-premises, on premises and at-premise are interchangeable and equivalent. Additionally, for those interested in heating and cooling their dwelling via renewable energy, geothermal heat pump systems that tap the constant temperature of the earth, which is around 7 to 15 degrees Celsius a few feet underground, are an option and save money over conventional natural gas and petroleum-fueled heat approaches.

The method may further comprise the steps of: monitoring the system from a remote location; and monitoring the utilized generation from a remote location. The method may comprise the steps of: generating an alert when the customer variables are a prescribed percentage different than historical averages. The method may also comprise the steps of monitoring and storing the consumer's customer variables and utilized generation.

Production data could come from, without limitation, PV System (kW or kWh), Solar thermal system (kW or kWh), Concentrated solar power system (kW or kWh) and Wind turbine (kW or kWh). Sensor data could come from, without limitation, Pyranometer (W/m̂2 or Wh/m̂2), Pyrheliometer (W/m̂2 or Wh/m̂2), PV reference cell (W/m̂2 or Wh/m̂2), Radiometer (W/m̂2 or Wh/m̂2), Pyrgeometer (W/m̂2 or Wh/m̂2), Anemometer (mph or m/s). This type of data consists of a hardware measurement (units listed beside hardware) and a corresponding point in time or time interval, producing a time series of data (multiple time points and data). For example, monitored PV production data is measured every 5 minutes, resulting in a 1 day dataset containing 288 measurements and timestamp pairs.

The present invention provides methods and systems for validating and augmenting solar irradiance and solar power production forecasts using a monitored network of solar power systems and solar irradiance sensors. Solar irradiance has impact across a variety of scientific fields including but not limited to meteorology, agronomy, and solar power. In meteorology, irradiance is absorbed by Earth's surface as heat, affecting the global mean temperature. In agronomy, irradiance causes growth in plants as well as impacting transpiration. In solar power, irradiance converts to electricity via the photovoltaic effect or it heats water for solar thermal energy. These are only a few of countless examples of physical processes influenced by solar irradiance, each further emphasizing the need for accurate sources of irradiance measurements.

Solar power is a rapidly growing source of power generation that faces many challenges to full integration into the electric grid. Intermittency of power production is inherent to solar power due to constantly changing weather conditions, and this is the largest challenge facing solar power. By forecasting weather conditions and modeling solar power output using these conditions, future volatility can be predicted. Using solar power forecasts, grid operators can intelligently plan for intermittency and mitigate the resulting impacts, hence the need for accurate solar power forecasts.

There exist many variants of solar irradiance forecast models, ranging from cloud motion forecasting to numerical weather prediction. FIG. 7 depicts a Solar Irradiance model graphic. The standard practice for irradiance forecast models is to provide model accuracy using a historical test period of data, resulting in the use of stale accuracy metrics in planning for model error. Additionally, these models generate new forecasts at low temporal resolution fixed intervals, typically relying on historical data from distantly related data sources for changes in the model. The inability of these models to incorporate a continuous stream of new input data is a flaw that can be remedied according to the present invention using adaptive statistical techniques.

Extensive scientific research has been conducted and published in the field of solar power modeling. These published models are based on the physics of the underlying solar power technology and have been tested in laboratories and in the field. Existing models, such as the single-diode model for photovoltaic systems have proven to be fairly accurate. While accurate, these models suffer from non-random errors that could potentially be reduced with statistical post-processing.

There is a clear and present need for high accuracy forecasts of solar irradiance and solar power production. Existing models have proven effective but they suffer from a number of flaws. One key fault of existing forecast models is an inability to continuously validate and augment forecasts in real-time. Additionally, these models do not leverage measurements from solar power systems or solar irradiance sensors, the most closely related sources of data for forecasts. The present invention provides methodology to validate the accuracy of solar irradiance and solar power forecasts in real-time. Also described is the methodology for applying machine learning techniques to augment solar irradiance and solar power forecasts using measurements from a monitored network of solar power installations and weather sensors and modeled variables from related computer models.

The present invention utilizes the following background variables, input parameters and logic based on those variables and parameters.

FORECAST VALIDATION LOGIC: This is logic for validating the accuracy of a forecast model. By comparing a subset of estimates from a forecast for which there exists corresponding sensor measurements, a validation metric of the overall forecast can be quantified.

FORECAST AUGMENTATION LOGIC: This is logic for augmenting estimates from a forecast model using measured and modeled data. By applying machine learning techniques to expired forecasts, observations, and other related variables, active forecasts can be augmented to reduce errors caused by hidden patterns in the underlying forecasting mechanism.

SOLAR IRRADIANCE FORECAST FEED: This is nowcasted and forecasted solar irradiance data obtained from an internet data feed and/or internal data feed. The feed includes global horizontal irradiance, direct normal irradiance, and diffuse horizontal irradiance, among other variables.

SOLAR POWER PRODUCTION FORECAST FEED: This is nowcasted and forecasted solar power production data obtained from an internet data feed and/or internal data feed. The feed includes AC power, current, and voltage among other variables.

SOLAR POWER PRODUCTION DATA FEED: This is power production data that is obtained from an internet data feed and/or a network of monitored solar power installations. The feed includes AC power, current, and voltage, among other variables. This data is obtained from physical hardware, including but not limited to a power meter or inverter.

WEATHER DATA FEED: This is weather data that is obtained from an internet data feed and/or a network of monitored weather sensors. The feed includes solar irradiance, snow cover, ambient temperature, wind speed, and dew point, among other variables. This data is estimated from computer models or measured by physical hardware, including but not limited to a pyranometer or solar panel for solar irradiance, a thermometer for temperature, and an anemometer for wind speed.

SATELLITE IMAGERY FEED: This is environmental imagery that is obtained from an internet data feed and/or monitored satellites. The feed includes visible spectrum imagery and infrared spectrum imagery, and the data contained in this imagery includes albedo and brightness temperature, among other variables. This imagery is captured by geosynchronous environmental satellites.

SOLAR IRRADIANCE MODEL: This is a quasi-empirical computer model that estimates solar irradiance using a proxy for atmospheric conditions. The atmospheric conditions proxy can be obtained from sources including but not limited to imagery from a satellite or sky imager, measurements from a weather sensor, and estimates from a computer model. Data from this model includes, but is not limited to solar irradiance, solar geometry, and atmospheric variables.

SOLAR POWER PRODUCTION MODEL: This is a physics-based computer model that converts weather data into solar power based on a solar installation's configuration (i.e. hardware, orientation, installation derates, etc.).

SOLAR IRRADIANCE FROM SOLAR POWER PRODUCTION MODEL: This is a quasi-empirical computer model that estimates the solar irradiance at the location of a solar power system. Using measurements of solar power production, a solar power production model can be reversed in order to estimate the solar irradiance received.

LOCATION & TIME VARIABLES: These are various variables corresponding to a location and time. These variables include latitude, longitude, altitude, date, and time, among other variables.

VALIDATION METRIC CALCULATIONS: These are formulas that calculate the statistical accuracy of models. These metrics include, but are not limited to, model error, mean absolute error, and root mean square error.

MACHINE LEARNING ALGORITHMS: These are algorithms that use an input dataset to adaptively generate predictions based on historical underlying relationships between the input and output. These algorithms include, but are not limited to, artificial neural networks and genetic algorithms. FIG. 8 depicts an Artificial Neural Network Example

Solar Irradiance Forecast Validation Methods. According to one aspect of the present invention, a computer processor implemented method of validating solar irradiance forecasts is provided, the method comprising the steps of; providing a set of renewable energy systems having at least two renewable energy systems each having a measured solar irradiance from a solar irradiance weather sensor at a location n and time t and an estimated solar irradiance from a solar irradiance forecast feed at a location n and time t in a computer processor; determining by the computer processor a set of matched pairs of location and time from the measured solar irradiance from a from weather sensor at a location n and time t and the estimated solar irradiance from a solar irradiance forecast feed at a location n and time t; calculating a validation metric of the set of matched pairs by the computer processor for at least one of: all locations at time t; location n at all times; all locations at all times; a subset of locations at time t; location n at a subset of times; and a subset of locations at a subset of times. The renewable energy system may be a photovoltaic system. The validation metric may be model error, mean absolute error and root mean square error.

ModelError=Estimate−Observed. Model Error formula.

Mean Absolute Error Formula.

$$Mean Absolute Error = \frac{1}{n} {\sum }_{i = n}^{n} \vert {Estimate}_{i} - {Observed}_{i} \vert$$

Root Mean Square Error Formula.

$$Root Mean Square Error = \sqrt{\frac{1}{n} {\sum }_{i = 1}^{n} {( {Estimate}_{i} - {Observed}_{i} )}^{2}}$$

The solar irradiance weather sensor may be a pyranometer, pyrheliometer and/or photovoltaic reference cell sensor.

This provides systems and methods for validating solar irradiance forecasts. Using a data feed or monitored weather stations, observed solar irradiance can be compared against forecasted solar irradiance in order to validate the accuracy of a forecast in real-time. A number of metrics for quantifying model accuracy can be used for validation, including but not limited to model error, mean absolute error, and root mean square error.

Definition of Variables

Measured Solar Irradianceₙₜ=Measurement of solar irradiance from a weather sensor at location n and at time t

Forecasted Solar Irradianceₙₜ=Estimate of solar irradiance from a solar irradiance forecast feed at location n and at time t

n=Location of measurement or estimate

t=Time of measurement or estimate

Validation of Solar Irradiance Forecasts

Pair up all Measured Solar Irradiance and Forecasted Solar Irradiance on both location and time

### Example

### Measured Solar Irradianceₙₜ and Forecasted Solar Irradianceₙₜ

Calculate validation metric (e.g. model error, mean absolute error, root mean square error, etc.) for any permutation of the sets below:

All locations at time t

Location n at all times

All locations at all times

A subset of locations at time t

Location n at a subset of times

A subset of locations at a subset of times

Solar Power Production Forecast Validation Methods. This aspect of the present invention provides methods and systems for validating solar power production forecasts. Using a data feed or monitored solar power installations, observed solar power production can be compared against forecasted solar power production in order to validate the accuracy of a forecast in real-time. Any metric for quantifying model accuracy can be used for validation including, but not limited to model error, mean absolute error, and root mean square error.

Definition of Variables

Measured Power Productionₙₜ=Measurement of solar power production from a power meter at location n and at time t.

Forecasted Power Productionₙₜ=Estimate of solar power production from a solar power production forecast feed at location n and at time t.

n=Location of measurement or estimate.

t=Time of measurement or estimate.

Validation of Solar Power Production Forecasts

Pair up all Measured Power Production and Forecasted Power Production on both location and time.

### Example

### Measured Power Productionₙₜ and Forecasted Power Productionₙₜ

Calculate validation metric (e.g. model error, mean absolute error, root mean square error, etc.) for any permutation of the sets below:

All locations at time t.

Location n at all times.

All locations at all times.

A subset of locations at time t.

Location n at a subset of times.

A subset of locations at a subset of times.

A computer processor implemented method of validating solar power production forecasts may comprise the steps of; providing a set of renewable energy systems having at least two renewable energy systems each having a measured power production from a from power meter at a location n and time t and an estimated solar power production from a solar power production forecast feed at a location n and time t in a computer processor; determining by the computer processor a set of matched pairs of location n and time t from the measured power production from a from power meter at a location n and time t and an estimated solar power production from a solar power production forecast feed at a location n and time t in a computer processor; calculating a validation metric of the set of matched pairs by the computer processor for at least one of: all locations at time t; location n at all times; all locations at all times; a subset of locations at time t; location n at a subset of times; and a subset of locations at a subset of times. The renewable energy system may be a photovoltaic system. The validation metric may be selected from the group consisting of model error, mean absolute error and root mean square error.

Solar Irradiance Forecast Augmentation Methods and Systems. FIG. 10 depicts a flowchart for Solar Power Production Forecast Augmentation.

This provides methods and systems for augmenting solar irradiance forecasts. Using a data feed or a network of monitored weather stations and solar power installations, solar irradiance forecasts can be augmented in real-time. By applying machine learning algorithms to data measured by satellites, weather stations, and solar power projects and data modeled by relevant computer models, patterns in forecast model errors can be adaptively identified and minimized through forecast augmentation. A number of machine learning algorithms can be used to augment forecasts, such as artificial neural networks, genetic algorithms, and support vector machines.

Definition of Variables

Measured Solar Irradianceₙₜ=Measurement of solar irradiance from a weather sensor at location n and at time t.

Brightness Temperatureₙₜ=Measurement or estimate of infrared brightness temperature from a satellite or computer model at location n and at time t.

Snow Coverₙₜ=Dummy variable representing snow cover (1 for snow and 0 for none) estimated from a satellite and weather stations or a computer model at location n and at time t

Ambient Temperatureₙₜ=Measurement or estimate of ambient temperature from a weather sensor or computer model at location n and at time t

Humidityₙₜ=Measurement or estimate of humidity from a weather sensor or computer model at location n and at time t

Dew Pointₙₜ=Measurement or estimate of humidity from a weather sensor or computer model at location n and at time t

Wind Speedₙₜ=Measurement or estimate of wind speed from a weather sensor or computer model at location n and at time t

Air Pressureₙₜ=Measurement or estimate of air pressure from a weather sensor or computer model at location n and at time t

Extraterrestial Solar Irradianceₙₜ=Estimate of solar irradiance reaching Earth's atmosphere from at a computer model at location n and at time t

Sun Earth Distanceₙₜ=Estimate of distance between Sun and Earth from a computer model at location n and at time t

Declinationₙₜ=Estimate of the angle between Earth's axis and plane perpendicular to line between the Sun and Earth from a computer model at location n and at time t

Hour Angleₙₜ=Estimate of the angular displacement of the Sun east or west of a point's longitude from a computer model at location n and at time t

Zenith Angleₙₜ=Estimate of the angle of the Sun relative to a line perpendicular to the Earth's surface from a computer model at location n and at time t

Solar Elevationₙₜ=Estimate of the angle between the Sun and horizon for a point on Earth from a computer model at location n and at time t

Air Massₙₜ=Estimate of air mass from a computer model at location n and at time t

Turbidityₙₜ=Estimate of turbidity from a computer model at location n and at time t

Cloudiness Indexₙₜ=Estimate of atmospheric cloudiness from a computer model at location n and at time t

Clear Sky Irradianceₙₜ=Estimate of solar irradiance reaching location n and at time t under clear sky conditions from a computer model

Estimated Solar Irradianceₙₜ=Estimate of solar irradiance from a solar irradiance from solar power model using measured solar power from a meter at location n and at time t

Altitudeₙₜ=Measurement or estimate of humidity from a weather sensor or computer model at location n and at time t

Hour of Dayₙₜ=Hour of day at location n and at time t

Month of Yearₙₜ=Month of year at location n and at time t

Forecasted Solar Irradianceₙₜ=Estimate of solar irradiance from a solar irradiance forecast feed at location n and at time t

n=Location of measurement or estimate

t=Time of measurement or estimate

d=Distance from location n for which all enclosed locations are used to augment estimates at location n

s=Time periods behind time t for which all enclosed time periods are used to augment estimates at time t

Augmentation of Solar Irradiance Forecasts

Match up all data at location n and at time t, including all locations within distance d of location n and all time periods within s time periods of time t at those locations. Data includes (where available):

Measured Solar Irradianceₙₜ₋₁, . . . Measured Solar Irradianceₙₜ₋ₛ

Estimated Solar Irradianceₙₜ₋₁, . . . Estimated Solar Irradianceₙₜ₋ₛ

Forecasted Solar Irradianceₙₜ, . . . Forecasted Solar Irradianceₙₜ₋ₛ

Brightness Temperatureₙₜ, . . . Brightness Temperatureₙₜ₋ₛ

Ambient Temperatureₙₜ, . . . Temperatureₙₜ₋ₛ

Humidityₙₜ, . . . Humidityₙₜ₋ₛ

Dew Pointₙₜ, . . . Dew Pointₙₜ₋ₛ

Wind Speedₙₜ, . . . Wind Speedₙₜ₋ₛ

Air Pressureₙₜ, . . . Air Pressure

Extraterrestrial Solar Irradianceₙₜ, . . . Extraterrestrial Solar Irradianceₙₜ₋ₛ

Sun Earth Distanceₙₜ, . . . Sun Earth Distanceₙₜ₋ₛ

Declinationₙₜ, . . . Declinationₙₜ₋ₛ

Hour Angleₙₜ, . . . Hour Angleₙₜ₋ₛ

Zenith Angleₙₜ, . . . Zenith Angleₙₜ₋ₛ

Air Massₙₜ, . . . Air Massₙₜ₋ₛ

Turbidityₙₜ, . . . Turbidityₙₜ₋ₛ

Cloudiness Indexₙₜ, . . . Cloudiness Indexₙₜ₋ₛ

Clear Sky Irradianceₙₜ, . . . Clear Sky Irradianceₙₜ₋ₛ

Altitudeₙₜ, . . . Altitudeₙₜ₋ₛ

Hour of Dayₙₜ, . . . Hour of Dayₙₜ₋ₛ

Month of Yearₙₜ, . . . Month of Yearₙₜ₋ₛ

The method comprises the step of training a machine learning algorithm to minimize: Σᵢ₌₁^{j}Measured Solar Irradianceₙᵢ−\hat{f}(•ₙᵢ)

Where j is the number of time points for which data is available to train the algorithm. Where •ₙᵢ is the dataset described in step 1 for location n at time i. Where \hat{f}(•ₙᵢ) is a function for predicting solar irradiance at location n at time i using data •ₙᵢ.

The next step may be to augment Forecasted Solar Irradianceₙₜ using the trained machine learning algorithm:

Augmented Forecasted Solar Irradianceₙₜ=\hat{f}(•ₙₜ)

Where •ₙₜ is the dataset described in step 1 for location n at time t. Where \hat{f}(•ₙₜ) is a function for predicting solar irradiance at location n at time t using data •ₙₜ.

Another aspect of the present invention provides a computer processor implemented method of augmenting solar irradiance forecasts, the method comprising the steps of; providing in a computer processor a set of solar irradiance sensors having at least two solar irradiance sensors each having a measurement of solar irradiance at location n and at time t and forecasted solar irradiance data at location n and at time t; determining in the computer processor at least one set of solar irradiance data variables at a location n and time t; matching by the computer processor all data variables at location n and time t, including all locations within distance d of location n and all time periods with s time periods of time t at those locations to provide a matched set of solar irradiance data variables at a location n and time t; training a machine learning algorithm to minimize to provide a trained machine learning algorithm according to Σᵢ₌₁^{j}Measured Solar Irradianceₙᵢ−\hat{f}(•ₙᵢ) where j is the number of time points for which data is available to train the algorithm, •ₙᵢ is the matched set of solar irradiance data variables at a location n and time t and \hat{f}(•ₙᵢ) is a function for predicting solar irradiance at location n at time i using data •ₙᵢ; augmenting the forecasted solar irradiance data using the trained machine learning algorithm: Augmented Forecasted Solar Irradianceₙₜ=\hat{f}(•ₙₜ) where •ₙₜ is the matched set of solar irradiance data variables at a location n and time t and \hat{f}(•ₙₜ) is a function for predicting solar irradiance at location n at time t using data •ₙₜ. FIG. 9 depicts a flowchart for Solar Irradiance Forecast Augmentation.

The set of solar irradiance data variables may include: estimated solar irradiance data using measured solar power from a meter at location n and time t; forecasted solar irradiance data from a solar irradiance forecast feed at location n and time t; infrared brightness temperatures at location n and time t; ambient temperature at location n and time t; humidity at location n and time t; dew point at location n and time t; wind speed at location n and time t; air pressure at location n and time t; extraterrestrial solar irradiance at location n and time t; sun earth distance at location n and time t; declination at location n and time t; hour angle at location n and time t; zenith angle at location n and time t; air mass at location n and time t; turbidity at location n and time t; cloudiness index at location n and time t; clear sky irradiance at location n and time t; altitude at location n and time t; hour of day at location n and time t; and month of year at location n and time t.

Solar Power Production Forecast Augmentation Methods and Systems

This aspect of the present invention provides systems and methods for augmenting solar power production forecasts. Using a data feed or a network of monitored weather stations and solar power installations, solar power production forecasts can be augmented in real-time. By applying machine learning algorithms to data measured by satellites, weather stations, and solar power projects, as well as data modeled by relevant computer models, patterns in forecast model errors can be adaptively identified and minimized through forecast augmentation. A number of machine learning algorithms can be used to augment forecasts, such as artificial neural networks, genetic algorithms, and support vector machines.

Definition of Variables

Measured Solar Irradianceₙₜ=Measurement of solar irradiance from a weather sensor at location n and at time t.

Measured Power Productionₙₜ=Measurement of solar power production from a meter at location n and at time t.

Brightness Temperatureₙₜ=Measurement or estimate of infrared brightness temperature from a satellite or computer model at location n and at time t.

Snow Coverₙₜ=Dummy variable representing snow cover (1 for snow and 0 for none) estimated from a satellite and weather stations or a computer model at location n and at time t.

Ambient Temperatureₙₜ=Measurement or estimate of ambient temperature from a weather sensor or computer model at location n and at time t.

Humidityₙₜ=Measurement or estimate of humidity from a weather sensor or computer model at location n and at time t.

Dew Pointₙₜ=Measurement or estimate of humidity from a weather sensor or computer model at location n and at time t.

Wind Speedₙₜ=Measurement or estimate of wind speed from a weather sensor or computer model at location n and at time t.

Air Pressureₙₜ=Measurement or estimate of air pressure from a weather sensor or computer model at location n and at time t.

Extraterrestial Solar Irradianceₙₜ=Estimate of solar irradiance reaching Earth's atmosphere from at a computer model at location n and at time t.

Sun Earth Distanceₙₜ=Estimate of distance between Sun and Earth from a computer model at location n and at time t.

Declinationₙₜ=Estimate of the angle between Earth's axis and plane perpendicular to line between the Sun and Earth from a computer model at location n and at time t.

Hour Angleₙₜ=Estimate of the angular displacement of the Sun east or west of a point's longitude from a computer model at location n and at time t.

Zenith Angleₙₜ=Estimate of the angle of the Sun relative to a line perpendicular to the Earth's surface from a computer model at location n and at time t.

Solar Elevationₙₜ=Estimate of the angle between the Sun and horizon for a point on Earth from a computer model at location n and at time t.

Air Massₙₜ=Estimate of air mass from a computer model at location n and at time t.

Turbidityₙₜ=Estimate of turbidity from a computer model at location n and at time t.

Cloudiness Indexₙₜ=Estimate of atmospheric cloudiness from a computer model at location n and at time t.

Clear Sky Irradianceₙₜ=Estimate of solar irradiance reaching location n and at time t under clear sky conditions from a computer model.

Estimated Solar Irradianceₙₜ=Estimate of solar irradiance from a solar irradiance from solar power model using measured solar power from a meter at location n and at time t.

Altitudeₙₜ=Measurement or estimate of humidity from a weather sensor or computer model at location n and at time t.

Hour of Dayₙₜ=Hour of day at location n and at time t.

Month of Yearₙₜ=Month of year at location n and at time t.

Forecasted Solar Irradianceₙₜ=Estimate of solar irradiance from a solar irradiance forecast feed at location n and at time t.

Forecasted Power Productionₙₜ=Estimate of solar power production from a solar power production forecast feed at location n and at time t.

n=Location of measurement or estimate.

t=Time of measurement or estimate.

d=Distance from location n for which all enclosed locations are used to augment estimates at location n.

s=Time periods behind time t for which all enclosed time periods are used to augment estimates at time t.

Augmentation of Solar Power Production Forecasts

Match up all data at location n and at time t, including all locations within d distance of location n and all time periods within s time periods of time t at those locations. Data includes (where available):

Measured Power Productionₙₜ₋₁, . . . Measured Power Productionₙₜ₋ₛ

Measured Solar Irradianceₙₜ₋₁, . . . Measured Solar Irradianceₙₜ₋ₛ

Estimated Solar Irradianceₙₜ₋₁, . . . Estimated Solar Irradianceₙₜ₋ₛ

Forecasted Solar Irradianceₙₜ, . . . Forecasted Solar Irradianceₙₜ₋ₛ

Forecasted Power Productionₙₜ, . . . Forecasted Power Productionₙₜ₋ₛ.

Brightness Temperatureₙₜ, . . . Brightness Temperatureₙₜ₋ₛ

Snow Coverₙₜ, . . . Snow Coverₙₜ₋ₛ

Ambient Temperatureₙₜ, Temperatureₙₜ₋ₛ

Humidityₙₜ, Humidityₙₜ₋ₛ

Dew Pointₙₜ, . . . Dew Pointₙₜ₋ₛ

Wind Speedₙₜ, . . . Wind Speedₙₜ₋ₛ

Air Pressureₙₜ, . . . Air Pressureₙₜ₋ₛ

Extraterrestrial Solar Irradianceₙₜ, . . . Extraterrestrial Solar Irradianceₙₜ₋ₛ.

Sun Earth Distanceₙₜ, . . . Sun Earth Distanceₙₜ₋ₛ

Declinationₙₜ, Declinationₙₜ₋ₛ.

Hour Angleₙₜ, . . . Hour Angleₙₜ₋ₛ

Zenith Angleₙₜ, . . . Zenith Angleₙₜ₋ₛ

Air Massₙₜ, . . . Air Massₙₜ₋ₛ

Turbidityₙₜ, Turbidityₙₜ₋ₛ

Cloudiness Indexₙₜ, . . . Cloudiness Indexₙₜ₋ₛ

Clear Sky Irradianceₙₜ, . . . Clear Sky Irradianceₙₜ₋ₛ

Altitudeₙₜ, Altitudeₙₜ₋ₛ

Hour of Dayₙₜ, . . . Hour of Dayₙₜ₋ₛ

Month of Yearₙₜ, . . . Month of Yearₙₜ₋ₛ

The method comprises the step of training a machine learning algorithm to minimize: Σᵢ₌₁^{j}Measured Solar Irradianceₙᵢ−\hat{f}(•ₙᵢ). Where j is the number of time points for which data is available to train the algorithm. Where •ₙᵢ is the dataset described in step 1 for location n at time i. Where \hat{f}(•ₙᵢ) is a function for predicting solar power production at location n at time i using data •ₙᵢ.

The next step may be to Augment Forecasted Power Productionₙₜ using the trained machine learning algorithm: Augmented Forecasted Solar Irradianceₙₜ=\hat{f}(•ₙₜ) where •ₙₜ is the dataset described in step 1 for location n at time t, and where \hat{f}(•ₙₜ) is a function for predicting solar power production at location n at time t using data

According to one aspect of the present invention, a computer processor implemented method of augmenting solar power production forecasts, said method comprising the steps of; providing in a computer processor a set of solar power meters having at least two solar power meters each having a measurement of power production at location n and at time t and forecasted power production at location n and at time t; determining in the computer processor at least one set of solar power production data variables at a location n and time t; matching by the computer processor all solar power production data variables at location n and time t, including all locations within distance d of location n and all time periods with s time periods of time t at those locations to provide a matched set of solar power production data variables at a location n and time t; training a machine learning algorithm to minimize to provide a trained machine learning algorithm according to: Σᵢ₌₁^{j}Measured Solar Irradianceₙᵢ−\hat{f}(•ₙᵢ) where j is the number of time points for which data is available to train the algorithm, •ₙᵢ is the matched set of solar power production data variables at a location n and time t and \hat{f}(•ₙᵢ) is a function for predicting solar power production at location n at time i using data •ₙᵢ; augmenting the forecasted solar power production data using the trained machine learning algorithm: Augmented Forecasted Solar Irradianceₙₜ=\hat{f}(•ₙₜ) where •ₙₜ is the matched set of solar power production data variables at a location n and time t and \hat{f}(•ₙₜ) is a function for predicting solar power production at location n at time t using data •ₙₜ.

The set of solar power production data variables may be selected from the group consisting of: measured solar irradiance data from a meter at location n and time t; estimated solar irradiance data using measured solar power from a meter at location n and time t; forecasted solar irradiance data from a solar irradiance forecast feed at location n and time t; infrared brightness temperatures at location n and time t; snow cover status at location n and time t; ambient temperature at location n and time t; humidity at location n and time t; dew point at location n and time t; wind speed at location n and time t; air pressure at location n and time t; extraterrestrial solar irradiance at location n and time t; sun earth distance at location n and time t; declination at location n and time t; hour angle at location n and time t; zenith angle at location n and time t; air mass at location n and time t; turbidity at location n and time t; cloudiness index at location n and time t; clear sky irradiance at location n and time t; altitude at location n and time t; hour of day at location n and time t; and month of year at location n and time t.

The present invention has many useful applications including, but not limited to, irradiance mapping of a geographic region, evaluation of solar projects and weather modeling.

Irradiance mapping of a geographic region: Sunlight mapping is used across a number of domains, since it is a geographic-based data set which users can apply to their particular problem. Similar to transportation maps, vegetation maps, political maps, etc., the irradiance maps can serve a wide variety of purposes for people needing to understand the geographic relationship, including how the geographic relationship has varied/will vary over time. Renewable energy evaluations: Forecasts can be used to estimate future output from solar photovoltaic systems. Building evaluations: Forecasts can be used to optimize the building control systems to lower operational costs (e.g., pre-cool the building on the morning of a forecasted sunny day, so as to consume the electrical energy earlier in the day when electric power prices are lower). In civil engineering and hydrology: Forecast irradiance maps can be used to operate forecasting numerical models of snowmelt runoff, an important tool for operating and predicting the water impact on everything from reservoir design for hydropower, dam and flood control infrastructure assessments, water availability for drinking water or agricultural purposes, etc.

Evaluation of solar projects: This is a specific sub-type of the general irradiance mapping use case described above. Electric grid integration: The impact of existing or planned solar projects upon the electric grid can be evaluated by examining changes to load and feeder lines due to solar projects. Using the forecast models described in this patent, existing solar projects can be modeled and planned solar projects can be simulated.

Weather modeling. Snow and ice coverage modeling: As described above in the civil engineering and hydrology section, irradiance has a significant impact on snow melt. The current and forecast irradiance can be used to estimate the amount of snowmelt that will occur, which determines the future state of the remaining snow and ice (i.e., irradiance is a key input to modeling the snow and ice coverage of an area). Estimating the albedo effects from changes in snow melt: Albedo is the reflection coefficient of a surface, and is an important concept in climatology, because it determines how much sunlight energy is absorbed as heat rather than reflected back into space. Snow has a high albedo, since it reflects most light. Since irradiance impacts snow melt, which in turn decreases albedo, which in turn affects the climate, the irradiance model in this patent plays an important role in estimating the future albedo in an area (i.e., the irradiance model can be used to predict snow melt, which can then be used to predict albedo as an input to climate models). Hydrology modeling: The irradiance model can be used to estimate snow melt, which provides input to models or estimates of available water for agriculture, drinking water, and other purposes.

It should be understood that the foregoing relates to preferred embodiments of the invention and that modifications may be made without departing from the spirit and scope of the invention as set forth in the following claims.

We claim:

1. A computer processor implemented method of validating solar irradiance forecasts, said method comprising the steps of;
providing a set of renewable energy systems having at least two renewable energy systems each having a measured solar irradiance from a solar irradiance weather sensor at a location n and time t and an estimated solar irradiance from a solar irradiance forecast feed at a location n and time t in a computer processor;
determining by the computer processor a set of matched pairs of location and time from the measured solar irradiance from a from weather sensor at a location n and time t and the estimated solar irradiance from a solar irradiance forecast feed at a location n and time t;
calculating by the computer processor a validation metric of the set of matched pairs by the computer processor for at least one of:
all locations at time t;
location n at all times;
all locations at all times;
a subset of locations at time t;
location n at a subset of times; and
a subset of locations at a subset of times.

2. A method as in claim 1, wherein said renewable energy system is a photovoltaic system.

3. A method as in claim 1, wherein the validation metric is selected from the group consisting of model error, mean absolute error and root mean square error.

4. A method as in claim 1, wherein said solar irradiance weather sensor is selected from the group consisting of pyranometer, pyrheliometer and photovoltaic reference cell sensor.

5. A computer processor implemented method of validating solar power production forecasts, said method comprising the steps of;
providing a set of renewable energy systems having at least two renewable energy systems each having a measured power production from a from power meter at a location n and time t and an estimated solar power production from a solar power production forecast feed at a location n and time t in a computer processor;
determining by the computer processor a set of matched pairs of location n and time t from the measured power production from a from power meter at a location n and time t and an estimated solar power production from a solar power production forecast feed at a location n and time t in a computer processor;
calculating by the computer processor a validation metric of the set of matched pairs by the computer processor for at least one of:
all locations at time t;
location n at all times;
all locations at all times;
a subset of locations at time t;
location n at a subset of times; and
a subset of locations at a subset of times.

6. A method as in claim 5, wherein said renewable energy system is a photovoltaic system.

7. A method as in claim 5, wherein the validation metric is selected from the group consisting of model error, mean absolute error and root mean square error.

8. A computer processor implemented method of augmenting solar irradiance forecasts, said method comprising the steps of;
providing in a computer processor a set of solar irradiance sensors having at least two solar irradiance sensors each having a measurement of solar irradiance at location n and at time t and forecasted solar irradiance data at location n and at time t;
determining in the computer processor at least one set of solar irradiance data variables at a location n and time t;
matching by the computer processor all data variables at location n and time t, including all locations within distance d of location n and all time periods with s time periods of time t at those locations to provide a matched set of solar irradiance data variables at a location n and time t;
training a machine learning algorithm in a computer processor to minimize to provide a trained machine learning algorithm according to:
Σᵢ₌₁^{j}Measured Solar Irradianceₙᵢ−\hat{f}(•ₙᵢ)
where j is the number of time points for which data is available to train the algorithm, •ₙᵢ is the matched set of solar irradiance data variables at a location n and time t and \hat{f}(•ₙᵢ) is a function for predicting solar irradiance at location n at time i using data •ₙᵢ;
augmenting the forecasted solar irradiance data using the trained machine learning algorithm:
Augmented Forecasted Solar Irradianceₙₜ=\hat{f}(•ₙₜ)
where •ₙₜ is the matched set of solar irradiance data variables at a location n and time t and \hat{f}(•ₙₜ) is a function for predicting solar irradiance at location n at time t using data •ₙₜ.

9. A method as in claim 8, wherein said set of solar irradiance data variables are selected from the group consisting of:
estimated solar irradiance data using measured solar power from a meter at location n and time t;
forecasted solar irradiance data from a solar irradiance forecast feed at location n and time t;
infrared brightness temperatures at location n and time t;
ambient temperature at location n and time t;
humidity at location n and time t;
dew point at location n and time t;
wind speed at location n and time t;
air pressure at location n and time t;
extraterrestrial solar irradiance at location n and time t;
sun earth distance at location n and time t;
declination at location n and time t;
hour angle at location n and time t;
zenith angle at location n and time t;
air mass at location n and time t;
turbidity at location n and time t;
cloudiness index at location n and time t;
clear sky irradiance at location n and time t;
altitude at location n and time t;
hour of day at location n and time t; and
month of year at location n and time t.

10. A computer processor implemented method of augmenting solar power production forecasts, said method comprising the steps of;
providing in a computer processor a set of solar power meters having at least two solar power meters each having a measurement of power production at location n and at time t and forecasted power production at location n and at time t;
determining in the computer processor at least one set of solar power production data variables at a location n and time t;
matching by the computer processor all solar power production data variables at location n and time t, including all locations within distance d of location n and all time periods with s time periods of time t at those locations to provide a matched set of solar power production data variables at a location n and time t;
training a machine learning algorithm in a computer processor to minimize to provide a trained machine learning algorithm according to:
Σᵢ₌₁^{j}Measured Solar Irradianceₙᵢ−\hat{f}(•ₙᵢ)
where j is the number of time points for which data is available to train the algorithm, •ₙᵢ is the matched set of solar power production data variables at a location n and time t and \hat{f}(•ₙᵢ) is a function for predicting solar power production at location n at time i using data •ₙᵢ;
augmenting the forecasted solar power production data using the trained machine learning algorithm:
Augmented Forecasted Solar Irradianceₙₜ=\hat{f}(•ₙₜ)
where •ₙₜ is the matched set of solar power production data variables at a location n and time t and \hat{f}(•ₙₜ) is a function for predicting solar power production at location n at time t using data •ₙₜ.

11. A method as in claim 10, wherein said set of solar power production data variables are selected from the group consisting of:
measured solar irradiance data from a meter at location n and time t;
estimated solar irradiance data using measured solar power from a meter at location n and time t;
forecasted solar irradiance data from a solar irradiance forecast feed at location n and time t;
infrared brightness temperatures at location n and time t;
snow cover status at location n and time t;
ambient temperature at location n and time t;
humidity at location n and time t;
dew point at location n and time t;
wind speed at location n and time t;
air pressure at location n and time t;
extraterrestrial solar irradiance at location n and time t;
sun earth distance at location n and time t;
declination at location n and time t;
hour angle at location n and time t;
zenith angle at location n and time t;
air mass at location n and time t;
turbidity at location n and time t;
cloudiness index at location n and time t;
clear sky irradiance at location n and time t;
altitude at location n and time t;
hour of day at location n and time t; and
month of year at location n and time t.

12. A computer processor implemented method of augmenting solar irradiance forecasts, said method comprising the steps of;
providing in a computer processor a set of solar irradiance sensors having at least two solar irradiance sensors each having a measurement of solar irradiance at location n and at time t and forecasted solar irradiance data at location n and at time t;
determining in the computer processor at least one set of solar irradiance data variables at a location n and time t;
matching by the computer processor all data variables at location n and time t, including all locations within distance d of location n and all time periods with s time periods of time t at those locations to provide a matched set of solar irradiance data variables at a location n and time t;
providing in a computer processor a set of solar power meters having at least two solar power meters each having a measurement of power production at location n and at time t and forecasted power production at location n and at time t;
determining in the computer processor at least one set of solar power production data variables at a location n and time t;
matching by the computer processor all solar power production data variables at location n and time t, including all locations within distance d of location n and all time periods with s time periods of time t at those locations to provide a matched set of solar power production data variables at a location n and time t;
training a machine learning algorithm in a computer processor to minimize to provide a trained machine learning algorithm according to:
Σᵢ₌₁^{j}Measured Solar Irradianceₙᵢ−\hat{f}(•ₙᵢ)
where j is the number of time points for which data is available to train the algorithm, •ₙᵢ is the matched set of solar irradiance data variables at a location n and time t and \hat{f}(•ₙᵢ) is a function for predicting solar irradiance at location n at time i using data •ₙᵢ;
augmenting the forecasted solar irradiance data using the trained machine learning algorithm:
Augmented Forecasted Solar Irradianceₙₜ=\hat{f}(•ₙₜ)
where •ₙₜ is the matched set of solar irradiance data variables at a location n and time t and \hat{f}(•ₙₜ) is a function for predicting solar irradiance at location n at time t using data •ₙₜ,
further training a machine learning algorithm in a computer processor to minimize to provide a trained machine learning algorithm according to:
Σᵢ₌₁^{j}Measured Solar Irradianceₙᵢ−\hat{f}(•ₙᵢ)
where j is the number of time points for which data is available to train the algorithm, •ₙᵢ is the matched set of solar power production data variables at a location n and time t and \hat{f}(•ₙᵢ) is a function for predicting solar power production at location n at time i using data •ₙᵢ;
augmenting the forecasted solar power production data using the trained machine learning algorithm:
Augmented Forecasted Solar Irradianceₙₜ=\hat{f}(•ₙₜ)
where •ₙₜ is the matched set of solar power production data variables at a location n and time t and \hat{f}(•ₙₜ) is a function for predicting solar power production at location n at time t using data •ₙₜ.

13. A method as in claim 12, wherein said set of solar irradiance data variables are selected from the group consisting of:
estimated solar irradiance data using measured solar power from a meter at location n and time t;
forecasted solar irradiance data from a solar irradiance forecast feed at location n and time t;
infrared brightness temperatures at location n and time t;
ambient temperature at location n and time t;
humidity at location n and time t;
dew point at location n and time t;
wind speed at location n and time t;
air pressure at location n and time t;
extraterrestrial solar irradiance at location n and time t;
sun earth distance at location n and time t;
declination at location n and time t;
hour angle at location n and time t;
zenith angle at location n and time t;
air mass at location n and time t;
turbidity at location n and time t;
cloudiness index at location n and time t;
clear sky irradiance at location n and time t;
altitude at location n and time t;
hour of day at location n and time t; and
month of year at location n and time t.

14. A method as in claim 12, wherein said set of solar power production data variables are selected from the group consisting of:
measured solar irradiance data from a meter at location n and time t;
estimated solar irradiance data using measured solar power from a meter at location n and time t;
forecasted solar irradiance data from a solar irradiance forecast feed at location n and time t;
infrared brightness temperatures at location n and time t;
snow cover status at location n and time t;
ambient temperature at location n and time t;
humidity at location n and time t;
dew point at location n and time t;
wind speed at location n and time t;
air pressure at location n and time t;
extraterrestrial solar irradiance at location n and time t;
sun earth distance at location n and time t;
declination at location n and time t;
hour angle at location n and time t;
zenith angle at location n and time t;
air mass at location n and time t;
turbidity at location n and time t;
cloudiness index at location n and time t;
clear sky irradiance at location n and time t;
altitude at location n and time t;
hour of day at location n and time t; and
month of year at location n and time t.

15. A computer processor implemented method of augmenting solar power production forecasts, said method comprising the steps of;
providing in a computer processor a set of solar power meters having at least two solar power meters each having a measurement of power production at location n and at time t and forecasted power production at location n and at time t;
determining in the computer processor at least one set of solar power production data variables at a location n and time t;
matching by the computer processor all solar power production data variables at location n and time t, including all locations within distance d of location n and all time periods with s time periods of time t at those locations to provide a matched set of solar power production data variables at a location n and time t;
providing in a computer processor a set of solar irradiance sensors having at least two solar irradiance sensors each having a measurement of solar irradiance at location n and at time t and forecasted solar irradiance data at location n and at time t;
determining in the computer processor at least one set of solar irradiance data variables at a location n and time t;
matching by the computer processor all data variables at location n and time t, including all locations within distance d of location n and all time periods with s time periods of time t at those locations to provide a matched set of solar irradiance data variables at a location n and time t;
training a machine learning algorithm to minimize to provide a trained machine learning algorithm according to:
Σᵢ₌₁^{j}Measured Solar Irradianceₙᵢ−\hat{f}(•ₙᵢ)
where j is the number of time points for which data is available to train the algorithm, •ₙᵢ is the matched set of solar power production data variables at a location n and time t and \hat{f}(•ₙᵢ) is a function for predicting solar power production at location n at time i using data •ₙᵢ;
augmenting the forecasted solar power production data using the trained machine learning algorithm:
Augmented Forecasted Solar Irradianceₙₜ=\hat{f}(•ₙₜ)
where •ₙₜ is the matched set of solar power production data variables at a location n and time t and \hat{f}(•ₙₜ) is a function for predicting solar power production at location n at time t using data •ₙₜ,
further training a machine learning algorithm to minimize to provide a trained machine learning algorithm according to:
Σᵢ₌₁^{j}Measured Solar Irradianceₙᵢ−\hat{f}(•ₙᵢ)
where j is the number of time points for which data is available to train the algorithm, •ₙᵢ is the matched set of solar irradiance data variables at a location n and time t and \hat{f}(•ₙᵢ) is a function for predicting solar irradiance at location n at time i using data •ₙᵢ;
augmenting the forecasted solar irradiance data using the trained machine learning algorithm:
Augmented Forecasted Solar Irradianceₙₜ=\hat{f}(•ₙₜ)
where •ₙₜ is the matched set of solar irradiance data variables at a location n and time t and \hat{f}(•ₙₜ) is a function for predicting solar irradiance at location n at time t using data •ₙₜ.

16. A method as in claim 15, wherein said set of solar irradiance data variables are selected from the group consisting of:
estimated solar irradiance data using measured solar power from a meter at location n and time t;
forecasted solar irradiance data from a solar irradiance forecast feed at location n and time t;
infrared brightness temperatures at location n and time t;
ambient temperature at location n and time t;
humidity at location n and time t;
dew point at location n and time t;
wind speed at location n and time t;
air pressure at location n and time t;
extraterrestrial solar irradiance at location n and time t;
sun earth distance at location n and time t;
declination at location n and time t;
hour angle at location n and time t;
zenith angle at location n and time t;
air mass at location n and time t;
turbidity at location n and time t;
cloudiness index at location n and time t;
clear sky irradiance at location n and time t;
altitude at location n and time t;
hour of day at location n and time t; and
month of year at location n and time t.

17. A method as in claim 15, wherein said set of solar power production data variables are selected from the group consisting of:
measured solar irradiance data from a meter at location n and time t;
estimated solar irradiance data using measured solar power from a meter at location n and time t;
forecasted solar irradiance data from a solar irradiance forecast feed at location n and time t;
infrared brightness temperatures at location n and time t;
snow cover status at location n and time t;
ambient temperature at location n and time t;
humidity at location n and time t;
dew point at location n and time t;
wind speed at location n and time t;
air pressure at location n and time t;
extraterrestrial solar irradiance at location n and time t;
sun earth distance at location n and time t;
declination at location n and time t;
hour angle at location n and time t;
zenith angle at location n and time t;
air mass at location n and time t;
turbidity at location n and time t;
cloudiness index at location n and time t;
clear sky irradiance at location n and time t;
altitude at location n and time t;
hour of day at location n and time t; and
month of year at location n and time t.
